(19) United States
(12) Patent Application Publication
(10) Pub. No.: US 2021/0133825 A1
(43) Pub. Date: May 6, 2021

(54) SECONDARY CONTENT DELIVERY SYSTEM

(71) Applicant: Google LLC, Mountain View, CA (US)

(72) Inventors: Pierre F. LEBEAU, Paris (FR); Kuan-Loong YONG, San Francisco, CA (US); Rory LAWTON, Dublin (IE); Venkatachari DILIP, Cupertino, CA (US)

(73) Assignee: Google LLC, Mountain View, CA (US)

(21) Appl. No.: 17/146,457

(22) Filed: Jan. 11, 2021

Related U.S. Application Data
(63) Continuation of application No. 15/717,518, filed on Sep. 27, 2017.
Application No. 15/717,518 is a continuation of application No. 12/263,912, filed on Nov. 3, 2008, now abandoned.

(51) Int. Cl. G06Q 30/02

(52) U.S. Cl. CPC G06Q 30/0276; G06Q 30/02

(57) ABSTRACT

Systems and methods for content (e.g., advertisements) delivery. An initial advertisement received by a user can include instructions for requesting a secondary advertisement. A user can follow the instructions to respond to the initial advertisement. A response to the initial advertisement can include a device identification. A secondary advertisement addressed to the device identification can be provided responsive to receiving a response from the user to the initial advertisement.

### CROSS-REFERENCE TO RELATED PATENT APPLICATIONS

This Application is a continuation of U.S. application Ser. No. 15/717,518, filed Sep. 27, 2017, which is a continuation of U.S. application Ser. No. 12/263,912, filed Nov. 3, 2008, the entities of which are incorporated by reference herein.

### BACKGROUND

This disclosure is related to information distribution.

Some of the non-Internet advertising that a typical person comes into contact with everyday is transitory in nature. When a user is presented with an ad while listening to the radio, playing a mobile game, or browsing a magazine, the user has to either act upon the content (“ad”) straightaway or move on.

### SUMMARY

Systems, methods and computer readable media for content (e.g., advertisements) delivery are provided. Example systems can include an initial advertisement distribution module and a secondary advertisement distribution module. The initial advertisement distribution module can provide an initial advertisement to a user in an initial format. The initial advertisement can include information associated with the advertiser and instructions for requesting the initial advertisement from the advertiser in a secondary format. The secondary advertisement distribution module can receive a response from the user. The response can include a device identification associated with the user. Based on receiving the response, the secondary advertisement distribution module can provide, for example, a secondary advertisement including a format conversion of the initial advertisement, the secondary advertisement being addressed to the device identification. The secondary advertisement can include the initial advertisement in the secondary format.

Example methods for providing content serving can include: providing an advertisement to a user, the advertisement being associated with an advertiser and comprising information associated with the advertiser and an invitation to respond to receive the advertisement in a messaging format from the advertiser; receiving a response from the user, the response comprising a device identification associated with the user; generating a message addressed to the device identification received from the user, the message being generated in the messaging format; and providing the message to a device associated with the device identification, the message providing the user a procedure to save the advertisement for subsequent action.

Other implementations are disclosed, including implementations directed to systems, methods, apparatuses, computer-readable mediums and user interfaces.

### BRIEF DESCRIPTION OF THE FIGURES

FIG. 1 is a block diagram of an example network architecture that can provide content delivery.

FIG. 2 is a block diagram of an example advertising server.

FIG. 3 is a flowchart of an example method for providing content.

### DETAILED DESCRIPTION

Secondary advertisements can enable users receiving an initial advertisement to respond to the initial advertisement to request secondary content or supplemental content. In some implementations, the response can include an indication of a device identification associated with the user. In some implementations, an advertising server can provide secondary content including a messaging based advertisement to the user based upon receiving a response to the initial advertisement from the user. In various implementations, the messaging based advertisement can be a format conversion of the initial advertisement, or a completely separate messaging based advertisement created by an advertiser. While reference is made to advertisements, other forms of content can be delivered including other forms of sponsored content. Further, while reference is made to a messaging system and delivery of an advertisement by way of a messaging systems, other forms of distribution are possible.

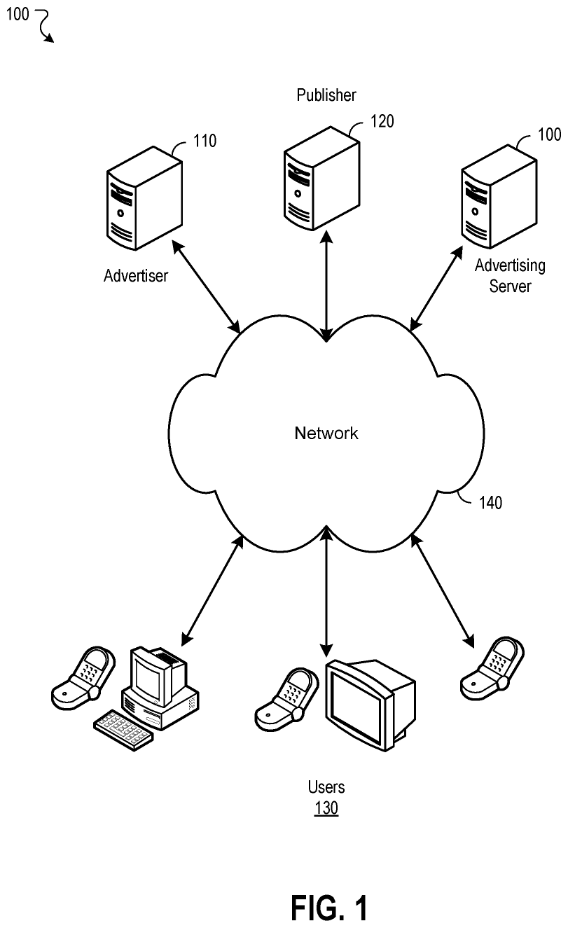

FIG. 1 is a block diagram of an example network architecture that can provide messaging based advertisements. An architecture can include an advertising server 100, an advertiser 110, a publisher 120, users 130 and a network 140. The publisher 120 can provide content to the users 130. The content distributed by the publisher 120 can include any type of media transmitted without prior contact with the user receiving the advertisement. Such media can include television, radio, print, and web-based ads (e.g., including text ads, graphical ads, audio ads, etc.), among many others.

In some implementations, the publisher 120 can provide content to users 130 that subscribe to a service provided by the publisher 120 through a network 140. For example, a user 130 might subscribe to a news service such as CNN or ESPN to receive news stories or sports scores. In other implementations, the publisher can be a search engine. The search engine, for example, can receive queries and respond to (e.g., serve) the queries. In still further implementations, the publisher 120 can broadcast the content without subscription and users can receive the content by tuning in to the broadcast.

In some implementations, the publisher 120 can derive revenue from providing the content based upon advertisements provided to the users 130 along with the content. In such implementations, the publisher 120 can supplement the content by, for example, appending, prepending, or otherwise inserting advertisements to/with the content (e.g., news stories, sports scores, search results, broadcast content, etc.) when the content is served to users 130 (e.g., subscribers, searchers, etc.).

The advertisements can be supplied to the publisher 120 by an advertising server 100. In some implementations, the advertisement selected for inclusion with the content can be based upon the content being served to the users 130. For example, if the content being served to the user includes football scores, the selected advertisement(s) could be related to football (e.g., sporting goods stores). In another implementation, the content can be associated with a demographic, and an advertisement can be selected based upon the demographic associated with the content. For example, if the content being served to the user is related to skateboarding, the demographic associated with skateboarding might be suburban teenagers. Suburban teenagers may not be interested in, for example, furniture advertisements, but might instead be interested in skateboard specialty stores or other retailers that cater to their demographic.

The advertisements can be created by an advertiser 110. The advertiser 110, in some implementations, can use an advertisement creation interface to interact with the advertising server 100 to create an initial advertisement. The advertiser 110 can additionally interact with an secondary advertisement creation interface to create a secondary advertisement associated with the initial advertisement. The secondary advertisement creation interface can enable the advertiser 110 to generate one or more secondary advertisements that can be served to the users 130 based upon their response to the initial advertisement. In various examples, secondary advertisements can be provided to any computing or storage device operable to receive communications from the advertising server, including, for example, through one or more gateway devices. Such computing devices can include mobile devices (e.g., cellular phone, laptop computer, personal digital assistant (PDA), etc.), stationary computer, electronic mail (e-mail) account(s), etc.

In some implementations, a response to the initial advertisement can result in a secondary advertisement being served to the user 130 sending the response. In some implementations, the secondary advertisement can provide a text message to the user 130, for example, using a short messaging service (SMS) or extended messaging service (XMS) format. In other implementations, a secondary advertisement can provide a multimedia message to the user 130, for example, using a multimedia messaging (MMS) format. In some implementations, the secondary advertisement can include a pointer or a link to the advertisement. In other implementations, the secondary advertisement can transcode the initial advertisement into a secondary advertisement or convert the initial advertisement from an initial format into a secondary format. For example, a speech advertisement can be converted to a text advertisement having the same content as the speech advertisement.

The secondary advertisement provided to a user can be based upon the response received from the user. In some implementations, the response can include an identification of the advertisement requested by the user. The identification, for example, can be derived from the particular advertising server (e.g., identified by internet protocol (IP) address) to which the response is being sent. For example, an advertising company might run several different advertisements, and the response address for the advertising server can be used to differentiate between which advertisement is being requested. In other examples, the response can include an identifier or a code word identifying a particular advertisement. In still further implementations, the advertisement itself can include an interface for requesting a secondary advertisement, which can automatically identify the advertisement based upon the interface used to request the secondary advertisement.

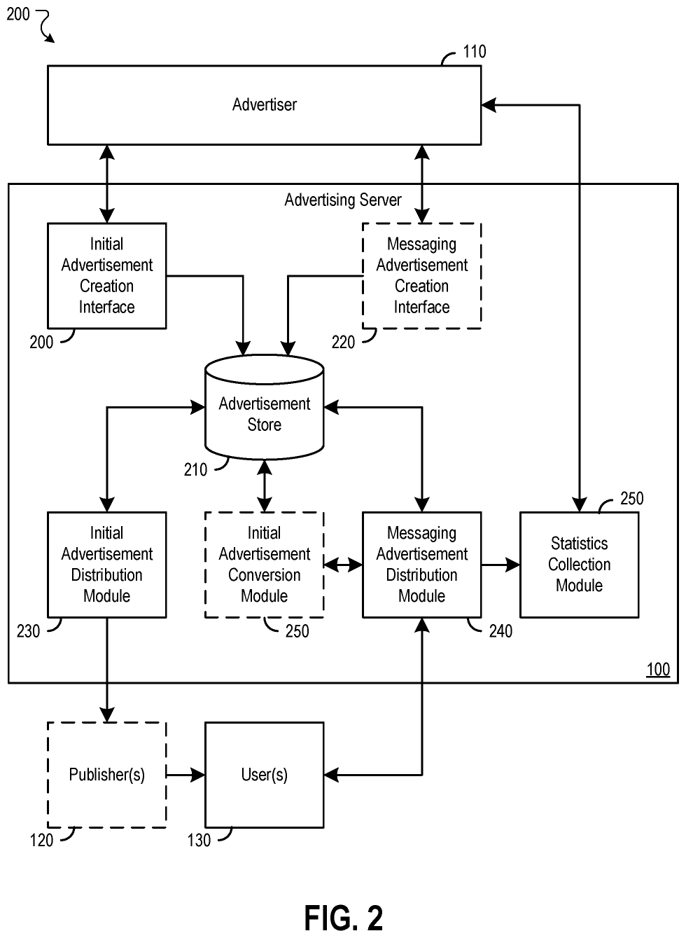

FIG. 2 is a block diagram of an example advertising server 100 operable to provide initial advertisements. The advertising server 100 can include an initial advertisement creation interface 200. The advertisement creation interface 200 can provide an interface to the advertiser 110 for creating initial advertisements in various formats including, for example, television, radio, print, and web-based ads, among many others. The initial advertisements created by the advertiser 110 using the initial advertisement creation interface 205 can be stored in an advertisement store 210.

In some implementations, the advertising server 100 can also include a secondary advertisement creation interface 220. The secondary advertisement creation interface 220 can receive secondary advertisement information from the advertiser 110. The secondary advertisement information can include information about the style and content of a secondary advertisement and can include information about which initial advertisement the secondary advertisement is to be associated.

In some implementations, the secondary advertisement can be provided in an SMS or XMS format. The content of the SMS formatted secondary advertisement can be limited to less than 160 characters. In other implementations, the secondary advertisement can be provided in an MMS format. Other communication protocols for mobile devices can be used.

In some implementations, the secondary advertisement can include a text based coupon. The text based coupon can facilitate the provision of a discount on goods or services associated with the advertisement. In various examples, the user can show the text based coupon to a provider by physically showing the provider the message. In other examples, the user can print the text based coupon and take the coupon in to the provider to receive a discount specified by the text based coupon.

In some implementations, the secondary advertisement can include a graphical bar code coupon operable to be scanned by a provider to verify the coupon. In some examples, the value of the graphical bar code coupon might be a mystery to the user, and might only be decoded by taking the graphical bar code coupon to the provider to decode the coupon. Thus, the graphical bar code coupon can identify the discount the user is entitled to receiving. In other examples, the graphical bar code coupon can be accompanied by a textual or graphical indication of the value of the coupon.

In further implementations, selection of the coupon on a mobile device during checkout can cause the mobile device to emit a signal. The signal can be received by a receiver associated with a checkout system, and can cause the checkout system to enter the coupon into the transaction. Thus, a user can communicate an electronic coupon to the checkout system by selecting the coupon in the mobile device. In various examples, the signal can be a wireless signal such as a cellular signal, a Bluetooth signal, an infrared signal, etc.

In some implementations, the secondary advertisement can be an actionable advertisement. Actionable advertisements can enable the user to select the advertisement through a user interface, and the secondary advertisement will interface with an application on the user device to perform a function described by the actionable advertisement. For example, the secondary advertisement might include an actionable address, selection of which can cause the user device to access a navigation application on the device to provide a map of the location associated with the address and/or directions to the location identified by the address from a current location of the device. In other examples, the actionable advertisement can be an electronic coupon, selection of which causes the device to emit an electromagnetic signal operable to be received by a point of sale device, the point of sale device automatically processing the electronic signal and applying a discount or rewards benefit to the transaction.

The secondary advertisement creation interface 220 can store the secondary advertisements in an advertisement store 210. In the implementation shown, the secondary advertisements are stored in the same data store 210 as the initial advertisements. However, in other implementations, the initial advertisements can be stored separately from the secondary advertisements. In some implementations, the secondary advertisements can be stored such that the secondary advertisements include information linking the secondary advertisements to the initial advertisements with which they are associated.

In some implementations, the advertising server 100 includes an initial advertisement distribution module 230. The initial advertisement distribution module 230 can receive requests for advertisements from a publisher 120. In some implementations, the request can include demographic or subject information. In such implementations, the initial advertisements distribution module 230 can select an advertisement from the advertisement store 210 based upon the demographic, subject or location information included with the request. For example, location information can be based upon the area code associated with the user sending the request, and the advertisements served to the user can be targeted based upon the location of the user. In some implementations, a selected initial advertisement can be returned to the publisher 120. In other implementations, the selected initial advertisement can be communicated directly to the user 130.

In those implementations where the selected initial advertisement is sent to the publisher 120, the publisher 120 can append, prepend or intersperse the selected initial advertisement with the content being sent to the user 130. For example, if the content included a television program, the initial advertisement can be inserted at specified slots within the television program by the publisher. In other examples, where the content includes football scores for a particular team, a targeted initial advertisement for sports apparel or sporting goods could be included along with the content being sent to the user 130.

The initial advertisement sent to the user 130 can include instructions for requesting a secondary advertisement associated with the initial advertisement. For example, the instructions can provide a codeword or number that can be included in the body of a response sent to the advertising server in order to request a secondary advertisement associated with the initial advertisement. The codeword or number can identify the initial advertisement for which the user is requesting a secondary advertisement from the advertising server 100. After sending the codeword or number to the advertising server, the device will receive the secondary advertisement associated with the initial advertisement. In other implementations, the initial advertisement can be identified based upon the address to which the response is sent. In still other implementations, the initial advertisement can include an interface for requesting the secondary advertisement, and the interface can append identification of the initial advertisement to the response sent when a user enters his/her mobile device identification into the interface.

When the user 130 provides a response to the advertising server 100, the response can be parsed by a secondary advertisement distribution module 240. The secondary advertisement distribution module 240 can operate to extract the mobile device identification associated with the response. The mobile device identification can be used by the secondary advertisement distribution module 240 to distribute the secondary advertisement. In some implementations, the secondary advertisement distribution module 240 can use the text associated with the response to determine which secondary advertisement the user is requesting. In such implementations, the secondary advertisement distribution module 240 can retrieve a secondary advertisement associated with the response based upon text extracted from the response.

In some implementations, the secondary advertisement associated with the response can be retrieved, for example, from an advertisement store 210. In other implementations, an initial advertisement conversion module 250 can be used to convert the initial advertisement from the format in which the advertisement was initially served (e.g., by retrieving the initial advertisement from the advertisement store 210) into an SMS or MMS messaging format. The secondary advertisement distribution module 240 can communicate the retrieved secondary advertisement to the user 130. The secondary advertisement can include, for example, a textual representation of the initial advertisement to which the user responded.

In some implementations, the advertising server 100 can include a statistics collection module 250. In such implementations, the secondary advertisement distribution module 240 can notify the statistics collection module 260 when a secondary advertisement is served to the user 130. The notification can include information about which text page is being served to the user 130. In some implementations, identifying information (e.g., including a mobile device identifier) associated with the user(s) 130 can be stripped from the data captured by the statistics collection module 260, unless the user, for example opts in to having the associated data collected.

The statistics collection module 260 can analyze the session information and derive navigation statistics associated with secondary advertisements served by the secondary advertisement distribution module 240. In some implementations, the navigation statistics can be made available through the statistics collection module 260 to the advertiser. The statistics collection module 260 can receive a statistics request from the advertiser 110. The request can indicate which of the statistics tracked by the statistics collection module 260 should be served to the advertiser 110. In response to the statistics request, the statistics collection module 260 can retrieve statistics associated with the request and format the statistics for presentation to the advertiser 110.

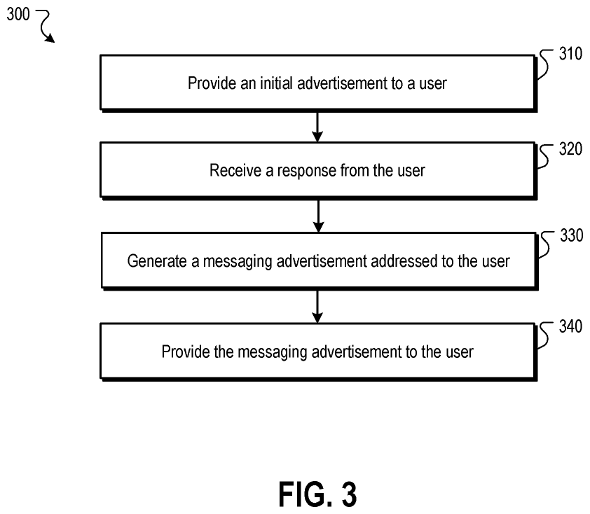

FIG. 3 is a flowchart of an example method 300 for providing secondary advertisements to users. At stage 310, an initial advertisement is provided to the user. The initial advertisement can be provided to the user, for example, by an advertising server (e.g., advertising server 100) including an initial advertisement distribution module (e.g., initial advertisement distribution module 230 of FIG. 2). In other examples, the initial advertisement can be provided by a publisher, independent of the operation of an advertisement server. The initial advertisement can include information describing how to request a secondary advertisement from the advertising server.

At stage 320, a response from the user can be received. The response can be received, for example, by a secondary advertisement distribution module (e.g., secondary advertisement distribution module 240 of FIG. 2). In some implementations, the response can include a mobile device identification associated with the user. The mobile device identification can identify a mobile device, such that when a message is addressed to the mobile device identification, the message will be routed to the mobile device associated with the mobile device identification. The response can provide a request to send a secondary advertisement to the mobile device. In some implementations, the response can also include an indication of the secondary advertisement being requested by the user. For example, the response can include a code identifying the initial advertisement and/or the secondary advertisement. In other examples, the response can be entered through an interface supplied by the initial advertisement, and the interface can append an identification of the initial advertisement and/or the secondary advertisement requested to the response. In still further examples, the address to which the response is directed can identify the initial advertisement and/or the secondary advertisement requested by the user.

At stage 330, a secondary advertisement addressed to the user is generated. The secondary advertisement addressed to the user can be generated, for example, by a secondary advertisement distribution module (e.g., secondary advertisement distribution module). The secondary advertisement can include a format conversion of the initial advertisement. The secondary advertisement, in some implementations, can be retrieved from an advertisement store (e.g., advertisement store 210 of FIG. 2). In other implementations, the secondary advertisement can be generated by an initial advertisement conversion module (e.g., initial advertisement conversion module 250 of FIG. 2). The secondary advertisement can be addressed to a mobile device identification received from the user within the response. Alternatively, the message can be otherwise addressed to a user.

At stage 340, the secondary advertisement can be provided to the user. The secondary advertisement can be provided to the user, for example, by a secondary advertisement distribution module (e.g., secondary advertisement distribution module 240 of FIG. 2). In some implementations, the secondary advertisement is provided to a mobile device associated with the user by transmitting the message using the mobile device identification as a destination address associated with the secondary advertisement. The secondary advertisement can include the secondary advertisement, and can facilitate the ability by the user to save the secondary advertisement for subsequent action.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1.-20. (canceled)

21. A method comprising:
transmitting, by one or more processors to a device, for presentation via a first application of the device, a first content item including an interactive element, the first content item including first instructions to cause the device to generate one or more requests to transmit one or more additional items of content responsive to an interaction with the interactive element;
receiving, by the one or more processors from the device, responsive to the interaction with the interactive element presented via the first application, a request for content including data used by the one or more processors to identify a second content item;
identifying, by the one or more processors responsive to receiving the request for content, the second content item stored in association with the first content item; and
transmitting, by the one or more processors, second instructions to the device to present the second content item via a second application of the device.

22. The method of claim 21, wherein identifying the second content item comprises identifying, by the one or more processors, the second content item and a third content item both stored in association with the first content item; and
wherein transmitting the second instructions to the device comprises transmitting, by the one or more processors, third instructions to the device to present the second content item and the third content via the second application of the device.

23. The method of claim 21, wherein the interactive element presented via the first application is a first interactive element, and wherein the second application comprises a second interactive element presented via the second application.

24. The method of claim 23, wherein the device is a first device, and wherein the method further comprises:
receiving, by the one or more processors from the first device, an indication of interaction with the second interactive element; and
transmitting, by the one or more processors, responsive to the interaction with the second interactive element, the second content item for presentation via a third application of a second device.

25. The method of claim 24, further comprising:
receiving, by the one or more processors from the second device, in response to the second content item presented via the third application, a response via the third application; and
transmitting, by the one or more processors to the first device, instructions to the second application of the first device to present the response in the second application executing on the first device.

26. The method of claim 21, wherein the interactive element is linked to the second application and wherein the device is configured to launch the second application responsive to the interaction with the interactive element.

27. The method of claim 21, wherein the second content item includes a plurality of content items, each content item including a respective interaction object, which when interacted with, causes the device to transmit, to a second device, a message corresponding to the respective interaction object.

28. The method of claim 21, wherein the first content item and the second content item are selected from one or more items of content stored in a data storage, the one or more items of content comprise at least one of text, link, image, or audio.

29. A system, comprising:
one or more processors configured to:
transmit, to a device, for presentation via a first application of the device, a first content item including an interactive element, the first content item including first instructions to cause the device to generate one or more requests to transmit one or more additional items of content responsive to an interaction with the interactive element;
receive, from the device, responsive to the interaction with the interactive element presented via the first application, a request for content including data used by the one or more processors to identify a second content item;
identify, responsive to receiving the request for content, the second content item stored in association with the first content item; and
transmit second instructions to the device to present the second content item via a second application of the device.

30. The system of claim 29, wherein identifying the second content item comprises identifying, by the one or more processors, the second content item and a third content item both stored in association with the first content item; and
wherein to transmit the second instructions to the device comprises transmit, by the one or more processors, third instructions to the device to present the second content item and the third content via the second application of the device.

31. The system of claim 29, wherein the interactive element presented via the first application is a first interactive element, and wherein the second application comprises a second interactive element presented via the second application.

32. The system of claim 31, wherein the device is a first device, and wherein the one or more processors further configured to:
receive, from the first device, an indication of interaction with the second interactive element; and
transmit, responsive to the interaction with the second interactive element, the second content item for presentation via a third application of a second device.

33. The system of claim 32, wherein the device is a first device, and wherein the one or more processors further configured to:
receive, from a second device, in response to the second content item presented via the third application, a response via a third application; and
transmit, to the first device, instructions to the second application of the first device to present the response in the second application executing on the first device.

34. The system of claim 29, wherein the interactive element is linked to the second application and wherein the device is configured to launch the second application responsive to the interaction with the interactive element.

35. The system of claim 29, wherein the second content item includes a plurality of content items, each content item including a respective interaction object, which when interacted with, causes the device to transmit, to the second device, a message corresponding to the respective interaction object.

36. The system of claim 29, wherein the first content item and the second content item are selected from one or more items of content stored in a data storage, the one or more items of content comprise at least one of text, link, image, or audio.

37. A non-transitory computer readable storage medium comprising instructions that, when executed by one or more processors, cause the one or more processors to perform operations comprising a method comprising:
transmitting, to a device, for presentation via a first application of the device, a first content item including an interactive element, the first content item including first instructions to cause the device to generate one or more requests to transmit one or more additional items of content responsive to an interaction with the interactive element;
receiving, from the device, responsive to the interaction with the interactive element presented via the first application, a request for content including data used by the one or more processors to identify a second content item;
identifying, responsive to receiving the request for content, the second content item stored in association with the first content item; and
transmitting, by the one or more processors, second instructions to the device to present the second content item via a second application of the device.

38. The non-transitory computer readable storage medium of claim 37, wherein identifying the second content item comprises identifying the second content item and a third content item both stored in association with the first content item; and
wherein transmitting the second instructions to the device comprises transmitting third instructions to the device to present the second content item and the third content via the second application of the device.

39. The non-transitory computer readable storage medium of claim 37, wherein the interactive element presented via the first application is a first interactive element, and wherein the second application comprises a second interactive element presented via the second application, and wherein the instructions that, when executed by the one or more processors, cause the one or more processors to perform operations comprising the method comprising:
receiving, from the first device, an indication of interaction with the second interactive element; and
transmitting, responsive to the interaction with the second interactive element, the second content item for presentation via a third application of a second device.

40. The non-transitory computer readable storage medium of claim 39, wherein the device is a first device, and wherein the instructions that, when executed by the one or more processors, cause the one or more processors to perform operations comprising the method comprising:
receiving, from a second device, in response to the second content item presented via the third application, a response via the third application; and
transmitting, to the first device, instructions to the second application of the first device to present the response in the second application executing on the first device.
